(19) United States
(12) Patent Application Publication
(10) Pub. No.: US 2016/0006736 A1
(43) Pub. Date: Jan. 7, 2016

(54) Method and system for implementing authentication and accounting in interaction between wireless local area network and fixed network

(71) Applicant: ZTE CORPORATION, Shenzhen, Guangdong (CN)

(72) Inventors: Jianjie You, Shenzhen (CN); Huaibin Wang, Shenzhen (CN)

(21) Appl. No.: 14/765,750

(22) PCT Filed: Sep. 17, 2013
(86) PCT No.: PCT/CN2013/083663

§ 371 Date: Aug. 4, 2015

(30) Foreign Application Priority Data
Feb. 5, 2013 (CN) 201310046354.5

(51) Int. Cl. H04L 29/06; H04W 12/06

(52) U.S. Cl. CPC H04L 63/0892; H04W 12/06; H04W 84/12

(57) ABSTRACT

Disclosed is a method for implementing authentication and accounting in the interaction between a wireless local area network (WLAN) and a fixed network. The method comprises: after a user equipment (UE) accesses a network, by means of a proxy function of an authentication, authorization and accounting server (AAA) of an access controller (AC), performing interaction between a broadband network gateway (BNG) and the AAA, and implementing authentication and accounting on the UE in sequence. Also disclosed at the same time is a system for implementing authentication and accounting in the interaction between a WLAN and a fixed network. By adopting the method and system of the present disclosure, authentication and accounting on a UE can be effectively implemented in the interaction between a WLAN and a fixed network.

### TECHNICAL FIELD

The present disclosure relates to a wireless communication technology, and in particularly, to a method and system for implementing authentication and accounting in interaction between a wireless local area network (WLAN) and a fixed network.

### BACKGROUND

With gradual maturity and popularity of the WLAN access technology, as well as the demand of users for high-speed wireless access, domestic and foreign service providers are developing WLAN services vigorously. The WLAN access technology, as splitting means in 2G and 3G, plays an increasingly important role.

The WLAN access technology is a complement to fixed network access. How to effectively know and manage a WLAN access situation of a user in real time becomes the key of development for the WLAN services. Moreover, this will help service providers carry out network optimization.

A WLAN network mainly consists of User Equipment (UE), an Access Point (AP), an Access Controller (AC), a Broadband Network Gateway (BNG) and an Authentication Authorization Accounting server (AAA), wherein the AP is a bridge between a wired network and a WLAN, and the UE may access external network resources via the AP.

Under the framework of interaction between a WLAN and a fixed network in the prior art, the functions of the AP, AC and BNG, AAA are not yet divided clearly, especially there is no solution about how to implement authentication and accounting on UE.

### SUMMARY

In view of above, the embodiments of the present disclosure aim to provide a method and system for implementing authentication and accounting in interaction between a WLAN and a fixed network, which can realize the authentication and accounting on UE in interaction between a WLAN and a fixed network.

To achieve the above purpose, the technical solution of embodiments of the present disclosure is achieved as follows.

An embodiment of the present disclosure provides a method for implementing authentication and accounting in interaction between a WLAN and a fixed network. The method includes that:

after UE accesses a network, a BNG interacts with an AAA and implements authentication and accounting on the UE in turn through an AAA proxy function of an AC.

Preferably, the BNG interacting with the AAA server and implementing authentication on the UE through the AAA proxy function of the AC may include:

sending, by the BNG, an authentication request message received from the UE to the AAA through the AAA proxy function of the AC; and

authenticating, by the AAA, the UE according to the authentication request message.

Preferably, sending, by the BNG, the authentication request message received from the UE to the AAA through the AAA proxy function of the AC may include:

sending, by the BNG, the authentication request message received from the UE to the AAA based on an AAA protocol; and

sending, by the AC, the authentication request message to the AAA based on the AAA protocol after receiving the authentication request message.

Preferably, after success of the authentication, the method may further include:

replying, by the AAA, an authentication success message to the AC based on the AAA protocol;

sending, by the AC, an AP a key of the UE contained in the received authentication success message and used to inform the AP that the authentication on the UE is successful, and replying, by the AC, an authentication success message to the BNG based on the AAA protocol;

after receiving the key of the UE, negotiating, by the AP, a new key with the UE; and

after receiving the authentication success message, storing, by the BNG, user information of the UE and replying an authentication success message to the UE;

the new key is for encrypting data transmitted by the UE.

Preferably, sending by the AC, the AP a key of the UE contained in the received authentication success message and used to inform the AP that the authentication on the UE is successful may include:

sending by the AC, the key of the UE to the AP through a control and provisioning of wireless access points protocol (CAPWAP) tunnel established between the AC and the AP.

Preferably, performing, by the BNG, interaction with the AAA server and implementing accounting on the UE through the AAA proxy function of the AC may include:

after assigning an Internet protocol (IP) address for the UE, sending, by the BNG, an accounting start message to the AC based on the AAA protocol;

after receiving the accounting start message, forwarding, by the AC as an AAA proxy, the accounting start message to the AAA based on the AAA protocol;

after receiving the accounting start message, implementing, by the AAA, accounting on the UE.

Preferably, the method may further include:

after receiving an address request message from the UE, assigning, by the BNG, the IP address for the UE and returning the assigned IP address to the UE.

Preferably, before the IP address is assigned for the UE, the method may further include:

determining, by the BNG, whether the UE passes the authentication according to a user identity in the address request message, and if the UE passes the authentication, assigning the IP address for the UE.

Preferably, during the accounting, the method may further include:

reporting, by the BNG, collected accounting information of the UE to the AC based on the AAA protocol;

forwarding, by the AC as the AAA proxy, the received accounting information of the UE to the AAA based on the AAA protocol;

making, by the AAA, accounting-related statistic according to the received accounting information of the UE.

Preferably, the accounting information may include traffic information of the UE.

Preferably, the accounting information may further include duration information of the UE.

Preferably, after the AC receives the accounting information of the UE, the method may further include:

making, by the AC, a user policy according to the accounting information of the UE when the user policy is needed to be made, and sending the user policy to the AP for execution.

Preferably, sending the user policy to the AP for execution may include:

sending, by the AC, the user policy to the AP through the CAPWAP tunnel established between the AC and the AP for execution.

Preferably, the method may further include:

sending, by the AC, a user offline notification message to the BNG when the accounting is needed to be terminated;

after receiving the user offline notification message, sending, by the BNG, an accounting termination message to the AC based on the AAA protocol;

after receiving the accounting termination message, forwarding, by the AC as an AAA proxy, the accounting termination message to the AAA based on the AAA protocol; and

after receiving the accounting termination message, terminating, by the AAA, the accounting on the UE.

Preferably, the accounting is needed to be terminated when an offline notification about the UE is received, or when the UE is detected to go offline, or when the UE is detected to meet an offline condition.

Preferably, detecting that the UE meets the offline condition may include:

detecting that data about traffic and/or duration used by the UE has reached an upper limit subscribed by the UE.

An embodiment of the present disclosure provides a system for implementing authentication and accounting in interaction between a WLAN and a fixed network. The system includes a BNG, an AC and an AAA; wherein,

the BNG is configured to interact with the AAA and implement authentication and accounting on the UE in turn through an AAA proxy function of the AC after user equipment (UE) accesses a network.

Preferably, the system may further include an AP and the UE; wherein,

the AAA is configured to, after success of the authentication, reply an authentication success message to the AC based on an AAA protocol;

the AC is configured to, after receiving the authentication success message replied by the AAA, send the AP a key of the UE contained in the received authentication success message and used to inform the AP that the authentication on the UE is successful, and reply an authentication success message to the BNG based on the AAA protocol;

the AP is configured to, after receiving from the AC the key of the UE that is used to inform the AP that the authentication on the UE is successful, negotiate a new key with the UE;

the BNG is further configured to, after receiving the authentication success message replied by the AC, store user information of the UE and reply an authentication success message to the UE; and

the UE is configured to negotiate the new key with the AP, and receive the authentication success message replied by the BNG;

wherein the new key is for encrypting data transmitted by the UE.

Preferably, before the BNG interacts with the AAA and implements the accounting on the UE through the AAA proxy function of the AC, the UE may be further configured to send an address request message to the BNG and receive an IP address assigned and returned by the BNG; and

the BNG may be further configured to, after receiving the address request message from the UE, assign the IP address for the UE and return the assigned IP address to the UE.

Preferably, before assigning the IP address for the UE, the BNG may be further configured to determine whether the UE passes the authentication according to a user identity in the address request message, and assign the IP address to the UE when determining that the UE passes the authentication.

Preferably, during the accounting, the BNG may be further configured to report collected accounting information of the UE to the AC based on the AAA protocol;

the AC is further configured to, after receiving the accounting information of the UE reported by the BNG, serve as an AAA proxy and forward the received accounting information of the UE to the AAA based on the AAA protocol; and

the AAA may be further configured to, after receiving the accounting information of the UE forwarded by the AC, make accounting-related statistic according to the received accounting information of the UE.

Preferably, the AC may be further configured to make a user policy according to the accounting information of the UE when the user policy is needed to be made, and send the user policy to the AP for execution.

Preferably, the AC may be further configured to send a user offline notification message to the BNG when the accounting is needed to be terminated, and after receiving an accounting termination message from the BNG, serve as an AAA proxy, and forward the accounting termination message to the AAA based on the AAA protocol;

the BNG may be further configured to, after receiving the user offline notification message from the AC, send the accounting termination message to the AC based on the AAA protocol; and

the AAA is further configured to, after receiving the accounting termination message forwarded by the AC, terminate the accounting on the UE.

According to the method and system for implementing authentication and accounting in interaction between a WLAN and a fixed network provided by the embodiments of the present disclosure, a BNG may interact with an AAA and implement authentication and accounting on UE in turn through an AAA proxy function of an AC after the UE accesses a network, authentication and accounting on the UE accordingly can be effectively implemented under the framework of interaction between a WLAN and a fixed network.

In addition, after receiving an address request message from the UE, the BNG may assign an IP address for the UE and return the assigned IP address to the UE, in this way, address assigning can be effectively implemented for users in the framework of interaction between a WLAN and a fixed network.

### BRIEF DESCRIPTION OF THE DRAWINGS

FIG. 1 is a schematic flowchart of a method for implementing authentication and accounting in interaction between a WLAN and a fixed network in accordance with an embodiment of the present disclosure;

FIG. 2 is a schematic diagram of a scenario of networking in accordance with embodiments of the present disclosure;

FIG. 3 is a schematic flowchart of a method for performing authentication on UE in interaction between a WLAN and a fixed network in accordance with the first embodiment of the present disclosure;

FIG. 4 is a schematic flowchart of a method for assigning an IP address and performing accounting in interaction between a WLAN and a fixed network in accordance with the second embodiment of the present disclosure;

FIG. 5 is a schematic flowchart of a method for reporting accounting information by a BNG in interaction between a WLAN and a fixed network in accordance with the third embodiment of the present disclosure;

FIG. 6 is a schematic flowchart of a method for terminating the accounting in interaction between a WLAN and a fixed network in accordance with the fourth embodiment of the present disclosure; and

FIG. 7 is a schematic structure diagram of a system for implementing authentication and accounting in interaction between a WLAN and a fixed network in accordance with an embodiment of the present disclosure.

### DETAILED DESCRIPTION

In the embodiments of the present disclosure, after UE accesses a network, a BNG interacts with an AAA and implements authentication and accounting on the UE in turn through an AAA proxy function of an AC.

The present disclosure is described in further detail below by specific embodiments in conjunction with the accompanying drawings.

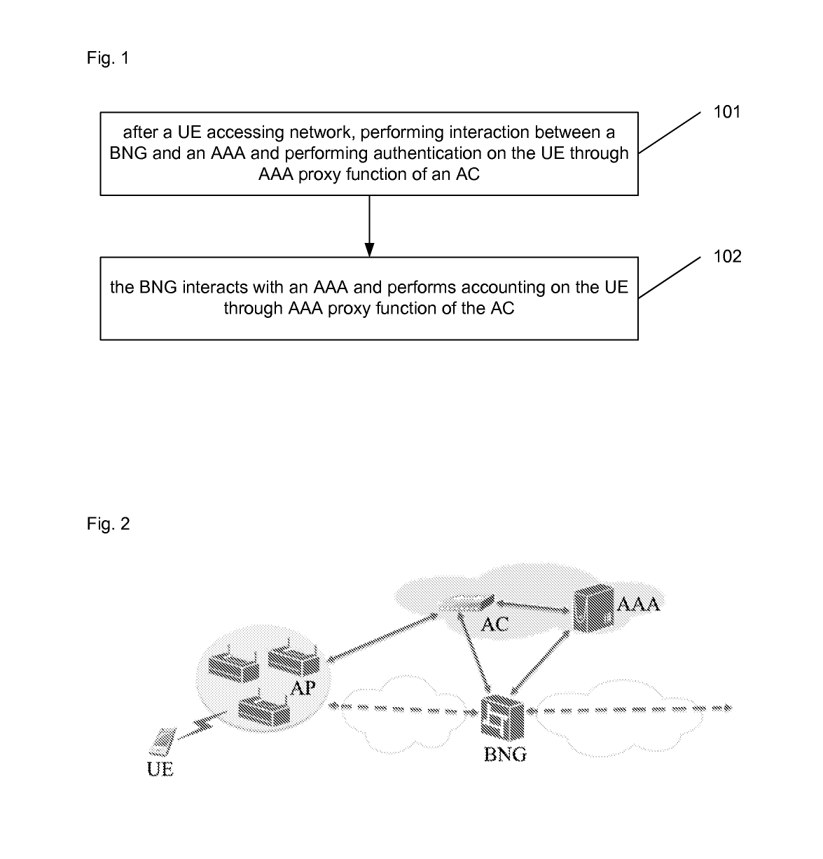

In an embodiment of the present disclosure, as shown in FIG. 1, a method for implementing authentication and accounting in interaction between a WLAN and a fixed network may include following steps.

Step 101 includes that after UE accesses a network, a BNG interacts with an AAA and implements authentication on the UE through an AAA proxy function of an AC;

wherein, this step may include:

the BNG sends an authentication request message received from the UE to the AAA through the AAA proxy function of the AC;

the AAA authenticates the UE according to the authentication request message.

In addition, the step of the BNG sending an authentication request message received from the UE to the AAA through the AAA proxy function of the AC may specifically include that:

the BNG sends the authentication request message received from the UE to the AAA based on an AAA protocol;

after receiving the authentication request message, the AC sends the authentication request message to the AAA based on the AAA protocol.

Further, the AAA protocol may be a RADIUS protocol, etc.

After success of the authentication, the method may further include that:

the AAA replies an authentication success message to the AC based on the AAA protocol;

the AC sends a key of the UE, which is contained in the received authentication success message and used to inform the AP that the authentication on the UE is successful, to the AP, and replies an authentication success message to the BNG based on the AAA protocol;

after receiving the key of the UE, the AP negotiates a new key with the UE;

after receiving the authentication success message, the BNG stores user information of the UE and replies an authentication success message to the UE.

Further, the step of the AC sending the AP a key of the UE contained in the received authentication success message and used to inform the AP that the authentication on the UE is successful may specifically include that:

the AC sends the key of the UE contained in the received authentication success message and used to inform the AP that the authentication on the UE is successful to the AP through a CAPWAP tunnel established between the AC and the AP.

The new key is for encrypting data transmitted by the UE.

Step 102 includes that the BNG interacts with the AAA and implements accounting on the UE through the AAA proxy function of the AC.

Specifically, after assigning an IP address for the UE, the BNG sends an accounting start message to the AC based on the AAA protocol;

after receiving the accounting start message, the AC as an AAA proxy forwards the accounting start message to the AAA based on the AAA protocol;

after receiving the accounting start message, the AAA performs accounting on the UE.

In addition, the method may further include that:

after receiving an address request message from the UE, the BNG assigns the IP address for the UE and returns the assigned IP address to the UE.

Here, before assigning the IP address for the UE, the method may further include that:

the BNG determines whether the UE passes the authentication according to a user identity in the address request message, and if the UE passes the, assigns the IP address for the UE.

Specifically, the user identity may be a medium access control (MAC) address, etc.

During the accounting, the method may further include that:

the BNG reports collected accounting information of the UE to the AC based on the AAA protocol;

the AC as the AAA proxy forwards the received accounting information of the UE to the AAA based on the AAA protocol;

the AAA makes accounting-related statistic according to the received accounting information of the UE.

Additionally, the accounting information may include traffic information of the UE; and further, the accounting information may include duration information of the UE, etc.

After the AC receives the accounting information of the UE, the method may further include that:

the AC makes a user policy according to the accounting information of the UE when the user policy is needed to be made, and sends the user policy to the AP for execution;

here, the step of sending the user policy to the AP for execution may include that:

the AC sends the user policy through the CAPWAP tunnel established between the AC and the AP to the AP for execution.

The method may further include that:

the AC sends a user offline notification message to the BNG when the accounting is needed to be terminated;

after receiving the user offline notification message, the BNG sends an accounting termination message to the AC based on the AAA protocol;

after receiving the accounting termination message, the AC as an AAA proxy forwards the accounting termination message to the AAA based on the AAA protocol;

after receiving the accounting termination message, the AAA terminates the accounting on the UE.

Here, the timing when the accounting is needed to be terminated may be a moment when an offline notification about the UE is received, or the moment when the UE is detected to go offline, or the moment when the UE is detected to meet an offline condition.

Here, detecting that the UE meets an offline condition may include:

detecting that data about traffic and/or duration used by the UE has reached the upper limit subscribed by of the UE.

The user offline notification message may carry the user identity of the UE.

The present disclosure is described in further detail below in conjunction with the embodiments.

FIG. 2 shows a scenario of networking in accordance with the first to fourth embodiments. In this scenario, UE is a 802.1X client; the UE accesses a wired network via an AP, and the AP has a capability to distinguish between 802.11 datagrams and 802.11 management/control messages; an AC is responsible for managing the AP and sending configuration parameters to the AP through a CAPWAP tunnel, while the AC is a RADIUS proxy; a BNG acts as a 802.1X authenticator and a RADIUS client; and an AAA is a RADIUS server. In FIG. 2, the solid line represents transmission direction of signalling streams, i.e., the transmission of signalling streams among the AAA, AC, AP and BNG; the dotted line represents the transmission direction of data streams, i.e., the transmission of data streams between the BNG and AP. In another words, datagrams from UE are sent to the BNG via the AP, and then sent to the network via the BNG; correspondingly, datagrams from the network are sent to the AP via the BNG, and then sent to the UE via the AP.

It is noted that, the interaction between the UE and the BNG in the first and second embodiments is implemented by direct forwarding via the AP.

### FIRST EMBODIMENT

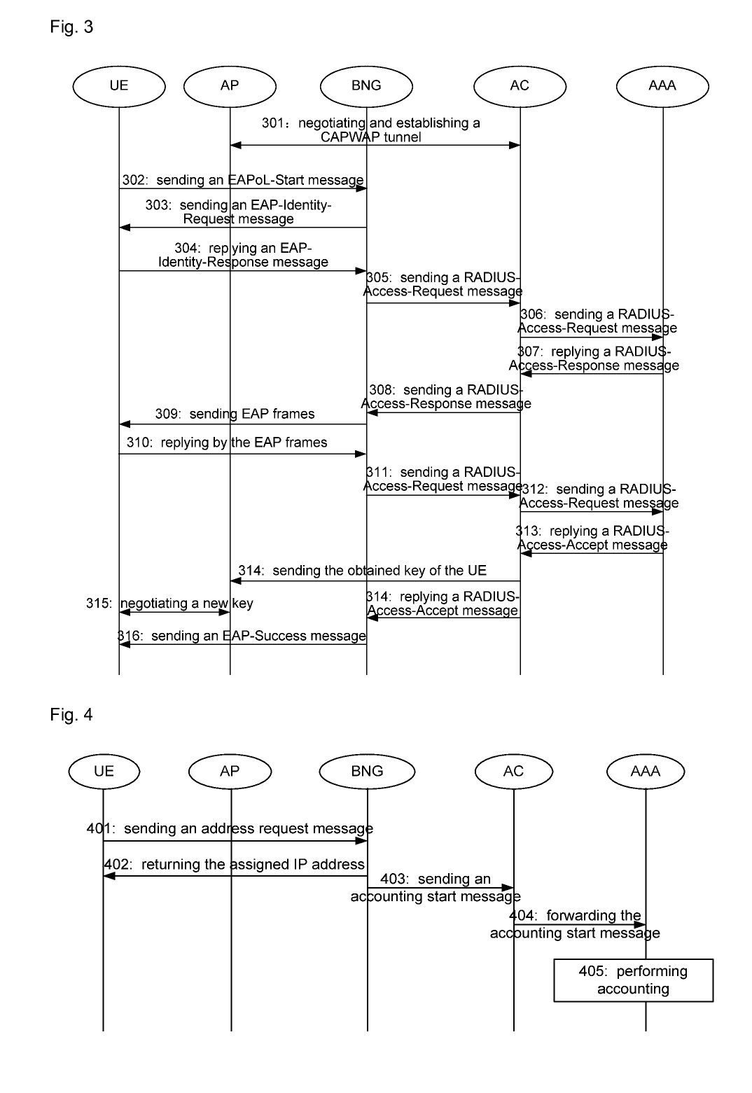

The application scenario of the present embodiment is an authentication process after UE is attached to a network; as shown in FIG. 3, in the present embodiment, a method for authenticating UE in interaction between a WLAN and a fixed network may include following steps.

Step 301 includes that after the UE is attached to the network, an AP negotiates with an AC and establishes a CAPWAP tunnel with the AC;

here, the AP has a capability to distinguish between 802.11 datagrams and 802.11 management/control messages transmitted by the UE.

The CAPWAP tunnel may be used to transmit 802.11 management/control messages, for example, to transmit a key that is used to inform the AP that the authentication on the UE is successful, etc.

Step 302 includes that the UE sends an authentication start (EAPoL-Start) message to the BNG for starting 802.1X authentication access.

Step 303 includes that after receiving the EAPoL-Start message, the BNG sends an identity request (EAP-Identity-Request) message to the UE for asking the UE to report its user identity.

Step 304 includes that after receiving the EAPoL-Start message, the UE replies an identity response (EAP-Identity-Response) message to the BNG;

here, the EAP-Identity-Response message may include the user identity.

Step 305 includes that after receiving the EAP-Identity-Response message, the BNG encapsulates an EAP frame into an authentication request (RADIUS-Access-Request) message and sends it to the AC based on a RADIUS protocol;

here, the BNG is an 802.1X authenticator and an AAA client.

The AC is a RADIUS proxy.

Step 306 includes that after receiving the RADIUS-Access-Request message, the AC sends the RADIUS-Access-Request message to an AAA server based on the RADIUS protocol;

here, the AAA protocol may specifically be a RADIUS protocol, etc.

Step 307 includes that after receiving the RADIUS-Access-Request message, the AAA replies an authentication request response (RADIUS-Access-Response) message to the AC based on RADIUS protocol;

here, the RADIUS-Access-Response message may include an Extensible Authentication Protocol (EAP) Challenge.

Step 308 includes that after receiving the RADIUS-Access-Response message, the AC sends the received RADIUS-Access-Response message to the BNG based on RADIUS protocol;

here, the RADIUS-Access-Response message sent to the BNG may include the EAP Challenge.

Step 309-310 include that after receiving the RADIUS-Access-Response message, the BNG decapsulates the message to obtain the EAP frame and send EAP frame to the UE; and after receiving the EAP frame, the UE replies to the BNG by the EAP frame;

here, the replied EAP frame may include a challenged password.

Step 311 includes that after receiving the EAP frame, the BNG encapsulates the received EAP frame into a RADIUS-Access-Request message and sends the RADIUS-Access-Request message to the AC based on the RADIUS protocol;

here, the RADIUS-Access-Request message may include the challenged password.

Step 312 includes that after receiving the RADIUS-Access-Request message, the AC sends the RADIUS-Access-Request message to the AAA server based on the RADIUS protocol.

Step 313 includes that after receiving the RADIUS-Access-Request message, the AAA performs an authentication, and if the authentication is successful, the AAA replies a RADIUS-Access-Accept message to the AC based on the RADIUS protocol;

here, the methods known in the prior art may be used to perform the authentication.

The RADIUS-Access-Accept message may carry at least a key of the UE.

Step 314 includes that after receiving the RADIUS-Access-Accept message, the AC obtains the key of the UE from the received RADIUS-Access-Accept message, sends the obtained key of the UE to the AP through the CAPWAP tunnel and then replies the RADIUS-Access-Accept message to the BNG based on the RADIUS protocol;

here, the obtained key of the UE may be used to inform the AP that the UE has past the authentication.

Step 315 includes that after receiving the key, the AP negotiates a new key with the UE;

here, the new key may be for encrypting data transmitted by the UE.

Step 316 includes that after receiving the RADIUS-Access-Accept message, the BNG stores user information of the UE and replies an EAP-Success message to the UE.

Here, the user information may include a user identity, such as a MAC address, a user name, etc.

It should be noted that as a RADIUS proxy, the AC can be aware of the authentication on the UE in the entire process of the authentication.

Then, the authentication is completed.

### SECOND EMBODIMENT

The application scenario of the present embodiment is that after the completion of flow in the first embodiment, i.e., after success of the authentication, an IP address is needed to be assigned for the UE and accounting is needed to be performed on the UE. In the present embodiment, as shown in FIG. 4, a method for assigning an IP address and performing accounting in interaction between a WLAN and a fixed network may include following steps.

Step 401 includes that after success of the authentication, the UE sends a DHCPv4/v6 address request message to the BNG;

here, the DHCPv4/v6 address request message may include a user identity, such as a MAC address.

Step 402 includes that after receiving the DHCPv4/v6 address request message, the BNG assigns an IP address for the UE and returns the assigned IP address to the UE;

here, before the IP address is assigned for the UE, the method may further include that:

the BNG determines whether the UE passes the authentication according to the user identity in the DHCPv4/v6 address request message, and if the UE passes the authentication, assigns the IP address for the UE.

Further, the BNG has stored the user identity of the UE in advance, and when determining whether the UE passes the authentication, compares the stored user identity of the UE with the user identity in the DHCPv4/v6 address request message, if both the user identities are the same, determines that the UE passes the authentication, otherwise, determines that the UE does not pass the authentication.

The user identity may specifically be a MAC address, etc.

If the BNG determines that the UE does not pass the authentication, then an IP address is not assigned for the UE, and correspondingly, the BNG may return an assignation failure message to the UE.

Here, the methods known in the prior art may be used to assign an IP address for the UE.

Step 403 includes that the BNG sends an accounting start message to the AC based on the RADIUS protocol.

Step 404 includes that after receiving the accounting start message, the AC as a RADIUS proxy forwards the accounting start message to the AAA based on the RADIUS protocol.

Step 405 includes that after receiving the accounting start message, the AAA performs accounting on the UE.

### THIRD EMBODIMENT

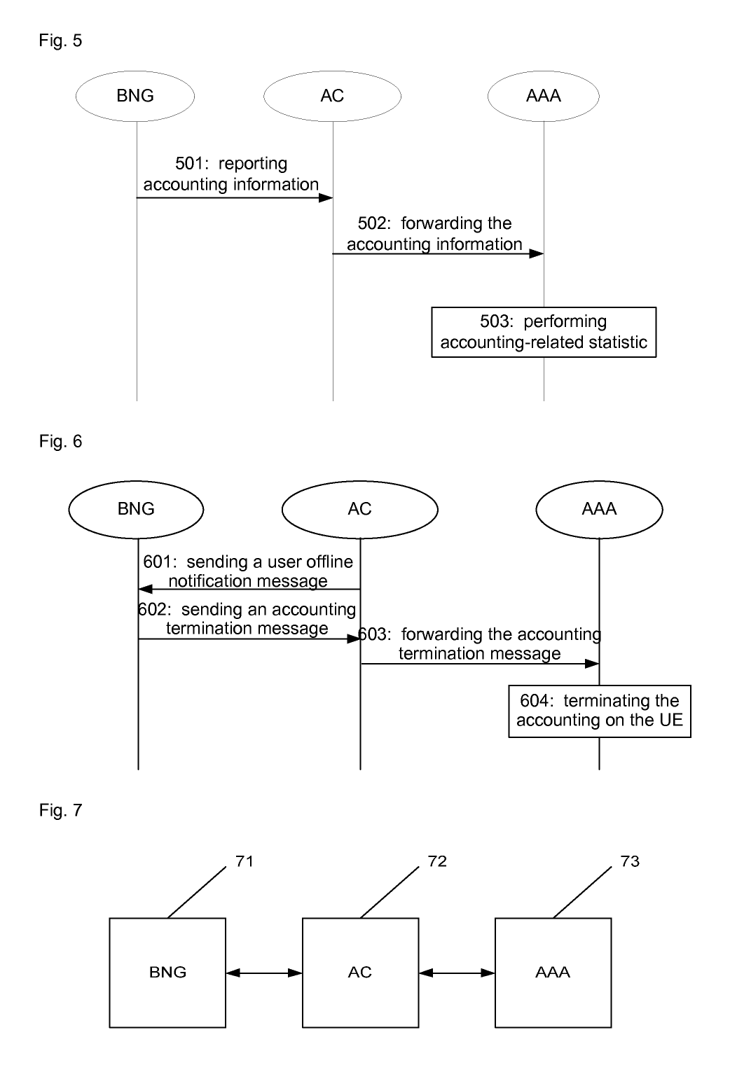

The application scenario of the present embodiment is that after the completion of the flow in the second embodiment, the BNG reports accounting information during the accounting. In the present embodiment, as shown in FIG. 5, a method for reporting accounting information by the BNG in interaction between a WLAN and a fixed network may include following steps.

Step 501 includes that the BNG collects accounting information of the UE and reports the collected accounting information of the UE to the AC based on the RADIUS protocol;

here, the methods known in the prior art may be used to implement this step.

The accounting information of the UE may include information about traffic, duration of the UE, etc.

Step 502 includes that after receiving the accounting information, the AC as a RADIUS proxy forwards the accounting information of the UE to the AAA based on RADIUS protocol;

here, the method may further include that:

the AC makes a user policy according to the accounting information of the UE when the user policy is needed to be made, and sends the user policy to the AP for execution.

The user policy may be made when the traffic used by the user is close to a threshold; that is to say, a user policy is made according to the accounting information of the UE reported by the BNG only when a user policy is needed to be made, instead of making a user policy whenever the accounting information of the UE reported by the BNG is received.

The AC sends the user policy to the AP through the established CAPWAP tunnel for execution.

Step 503 includes that after receiving the accounting information, the AAA makes accounting-related statistic according to the received accounting information of the UE.

### FOURTH EMBODIMENT

The application scenario of the present embodiment is a process where the accounting is terminated based on the second and third embodiments. In the present embodiment, as shown in FIG. 6, a method for terminating accounting in interaction between a WLAN and a fixed network may include following steps.

Step 601 includes that the AC sends a user offline notification message to the BNG when the accounting is needed to be terminated;

here, the accounting is needed to be terminated when an offline notification about the UE is received, or when the UE is detected to go offline, or when the UE is detected to meet an offline condition;

wherein, detecting that the UE meets an offline condition may include:

detecting that the data about traffic and/or duration used by the UE has reached the upper limit subscribed by of the UE.

The user offline notification message may carry a user identity of the UE, such as an IP address, a MAC address, etc.

Step 602 includes that after receiving the user offline notification message, the BNG sends an accounting termination message to the AC based on the RADIUS protocol.

Step 603 includes that after receiving the accounting termination message, the AC as a RADIUS proxy forwards the accounting termination message to the AAA based on the RADIUS protocol;

Step 604 includes that after receiving the accounting termination message, the AAA terminates the accounting on the UE.

In order to achieve the above methods, an embodiment of the present disclosure further provides a system for implementing authentication and accounting in interaction between a WLAN and a fixed network. As shown in FIG. 7, the system includes a BNG 71, an AC 72 and an AAA 73; wherein,

the BNG 71 is configured to, after UE accesses a network, interact with the AAA 73 and implement authentication and accounting on the UE in turn through an AAA proxy function of the AC 72.

Further, the system may include an AP and the UE; wherein,

the AAA 73 is configured to, after success of the authentication, reply an authentication success message to the AC 72 based on an AAA protocol;

the AC 72 is configured to, after receiving the authentication success message replied by the AAA 73, send the AP a key of the UE contained in the received authentication success message and used to inform the AP that the authentication on the UE is successful, and reply an authentication success message to the BNG 71 based on the AAA protocol;

the AP is configured to, after receiving from the AC 72 the key of the UE that is used to inform the AP that the authentication on the UE is successful, negotiate a new key with the UE;

the BNG 71 is further configured to, after receiving the authentication success message replied by the AC 72, store user information of the UE and reply an authentication success message to the UE;

the UE is configured to negotiate the new key with the AP, and receive the authentication success message replied by the BNG 71.

Before the BNG 71 interacts with the AAA 73 and implements the accounting on the UE through the AAA proxy function of the AC 72, the UE is further configured to send an address request message to the BNG 71 and receive an assigned IP address returned by the BNG 71;

the BNG 71 is further configured to, after receiving the address request message from the UE, assign an IP address for the UE and return the assigned IP address to the UE.

Before assigning the IP address for the UE, the BNG 71 is further configured to determine whether the UE passes the authentication according to a user identity in the address request message, and if the UE passes the authentication, assign the IP address for the UE.

During the accounting, the BNG 71 is further configured to report the collected accounting information of the UE to the AC 72 based on the AAA protocol;

the AC 72 is further configured to, after receiving the accounting information of the UE reported by the BNG 71, serve as the AAA proxy and forward the received accounting information of the UE to the AAA 73 based on the AAA protocol;

the AAA 73 is further configured to, after receiving the accounting information of the UE forwarded by the AC, make accounting-related statistic according to the received accounting information of the UE.

The AC 72 is further configured to make a user policy according to the accounting information of the UE when the user policy is needed to be made, and send the user policy to the AP for execution.

The AC 72 is further configured to send a user offline notification message to the BNG 71 when the accounting is needed to be terminated; and configured to, after receiving an accounting termination message from the BNG 71, serve as an AAA proxy, and forward the accounting termination message to the AAA 73 based on the AAA protocol;

the BNG 71 is further configured to, after receiving the user offline notification message from the AC 72, send the accounting termination message to the AC 72 based on the AAA protocol; and

the AAA 73 is further configured to, after receiving the accounting termination message forwarded by the AC 72, terminate the accounting on the UE.

The above are only the preferred embodiments of the present disclosure, and are not intended to limit the protection scope of the present disclosure.

1. A method for implementing authentication and accounting in interaction between a wireless local area network (WLAN) and a fixed network, comprising:
after user equipment (UE) accesses a network, performing, by a broadband network gateway (BNG), interaction with an authentication authorization accounting server (AAA) and implementing authentication and accounting on the UE in turn through an AAA proxy function of an access controller (AC).

2. The method according to claim 1, wherein performing interaction between the BNG and the AAA server and implementing authentication on the UE through the AAA proxy function of the AC comprises:
sending, by the BNG, an authentication request message received from the UE to the AAA through the AAA proxy function of the AC; and
authenticating, by the AAA, the UE according to the authentication request message.

3. The method according to claim 2, wherein sending, by the BNG, the authentication request message received from the UE to the AAA through the AAA proxy function of the AC comprises:
sending, by the BNG, the authentication request message received from the UE to the AC based on an AAA protocol; and
sending, by the AC, the authentication request message to the AAA based on the AAA protocol after the AC receives the authentication request message.

4. The method according to claim 3, after the authentication succeeds, the method further comprising:
replying, the AAA, an authentication success message to the AC based on the AAA protocol;
sending, by the AC, an access point (AP) a key of the UE contained in the received authentication success message and used to inform the AP that the authentication on the UE is successful, and replying, by the AC, an authentication success message to the BNG based on the AAA protocol;
negotiating, by the AP, a new key with the UE after receiving the key of the UE; and
storing, by the BNG, user information of the UE after receiving the authentication success message; and
replying, by the BNG, an authentication success message to the UE;
wherein the new key is for encrypting data transmitted by the UE.

5. The method according to claim 4, wherein sending, by the AC, to the AP the key of the UE contained in the received authentication success message and used to inform the AP that the authentication on the UE is successful comprises:
sending, by the AC, the key of the UE contained in the received authentication success message and used to inform the AP that the authentication on the UE is successful to the AP through a control and provisioning of wireless access points protocol (CAPWAP) tunnel established between the AC and the AP.

6. The method according to claim 1, wherein performing, by the BNG, interaction with the AAA server and implementing accounting on the UE through the AAA proxy function of the AC comprises:
sending, by the BNG, an accounting start message to the AC based on an AAA protocol after assigning an Internet protocol (IP) address for the UE;
forwarding, by the AC as an AAA proxy, the accounting start message to the AAA based on the AAA protocol after receiving the accounting start message; and
implementing, by the AAA, accounting on the UE after receiving the accounting start message.

7-8. (canceled)

9. The method according to claim 6, during the accounting, the method further comprising:
reporting, by the BNG, accounting information of the UE collected by the BNG to the AC based on the AAA protocol;
forwarding, by the AC as the AAA proxy, the received accounting information of the UE to the AAA based on the AAA protocol; and
making, by the AAA, accounting-related statistic according to the received accounting information of the UE.

10. The method according to claim 9, wherein the accounting information comprises traffic information of the UE, and further comprises duration information of the UE.

11. (canceled)

12. The method according to claim 9, after the AC receives the accounting information of the UE, the method further comprising:
making, by the AC, a user policy according to the accounting information of the UE when the user policy is needed to be made, and sending the user policy to the AP for execution.

13. The method according to claim 12, wherein sending the user policy to the AP for execution comprises:
sending, by the AC, the user policy to the AP through a CAPWAP tunnel established between the AC and the AP for execution.

14. The method according to claim 6, further comprising:
sending, by the AC, a user offline notification message to the BNG when the accounting is needed to be terminated;
sending, by the BNG, an accounting termination message to the AC based on the AAA protocol after receiving the user offline notification message;
forwarding, the AC as an AAA proxy, the accounting termination message to the AAA based on the AAA protocol after receiving the accounting termination message; and
terminating, by the AAA, the accounting on the UE after receiving the accounting termination message.

15. The method according to claim 14, wherein the accounting is needed to be terminated when an offline notification about the UE is received, or when the UE is detected to go offline, or when the UE is detected to meet an offline condition.

16. The method according to claim 15, wherein detecting that the UE meets the offline condition comprises:
detecting that data about traffic and/or duration used by the UE has reached an upper limit subscribed by the UE.

17. A system for implementing authentication and accounting in interaction between a wireless local area network (WLAN) and a fixed network, comprising a broadband network gateway (BNG), an access controller (AC) and an authentication authorization accounting server (AAA); wherein,
the BNG is configured to interact with the AAA and implement authentication and accounting on the UE in turn through an AAA proxy function of the AC after user equipment (UE) accesses a network.

18. The system according to claim 17, further comprising an access point (AP) and the UE; wherein,
the AAA is configured to, after success of the authentication, reply an authentication success message to the AC based on an AAA protocol;
the AC is configured to, after receiving the authentication success message replied by the AAA, send the AP a key of the UE contained in the received authentication success message and used to inform the AP that the authentication on the UE is successful, and reply an authentication success message to the BNG based on the AAA protocol;
the AP is configured to, after receiving from the AC the key of the UE that is used to inform the AP that the authentication on the UE is successful, negotiate a new key with the UE;
the BNG is further configured to, after receiving the authentication success message replied by the AC, store user information of the UE and reply an authentication success message to the UE; and
the UE is configured to negotiate the new key with the AP, and receive the authentication success message replied by the BNG;
wherein the new key is for encrypting data transmitted by the UE.

19. The system according to claim 18, wherein before the BNG interacts with the AAA and implements the accounting on the UE through the AAA proxy function of the AC, the UE is further configured to send an address request message to the BNG and receive an IP address assigned and returned by the BNG; and
the BNG is further configured to, after receiving the address request message from the UE, assign the IP address for the UE and return the assigned IP address to the UE.

20. The system according to claim 19, wherein before assigning the IP address for the UE, the BNG is further configured to determine whether the UE passes the authentication according to a user identity in the address request message, and assign the IP address to the UE when determining that the UE passes the authentication.

21. The system according to claim 17, wherein during the accounting, the BNG is further configured to report accounting information of the UE collected to the AC based on the AAA protocol;
the AC is further configured to, after receiving the accounting information of the UE reported by the BNG, serve as an AAA proxy and forward the received accounting information of the UE to the AAA based on the AAA protocol; and
the AAA is further configured to, after receiving the accounting information of the UE forwarded by the AC, make accounting-related statistic according to the received accounting information of the UE.

22. The system according to claim 21, wherein the AC is further configured to make a user policy according to the accounting information of the UE when the user policy is needed to be made, and send the user policy to the AP for execution.

23. The system according to claim 17, wherein the AC is further configured to send a user offline notification message to the BNG when the accounting is needed to be terminated, and after receiving an accounting termination message from the BNG, serve as an AAA proxy and forward the accounting termination message to the AAA based on the AAA protocol;
the BNG is further configured to, after receiving the user offline notification message from the AC, send the accounting termination message to the AC based on the AAA protocol; and
the AAA is further configured to, after receiving the accounting termination message forwarded by the AC, terminate the accounting on the UE.
